(19) United States
(12) Patent Application Publication
(10) Pub. No.: US 2015/0281649 A1
(43) Pub. Date: Oct. 1, 2015

(54) SYSTEM AND METHOD FOR AUGMENTED REALITY-ENABLED INTERACTIONS AND COLLABORATION

(71) Applicant: Futurewei Technologies, Inc., Plano, TX (US)

(72) Inventors: Jana EHMANN, San Francisco, CA (US); Liang ZHOU, Sichuan Province (CN); Onur G. GULERYUZ, San Francisco, CA (US); Fengjun LV, Sunnyvale, CA (US); Fengqing ZHU, Sunnyvale, CA (US); Naveen DHAR, San Jose, CA (US)

(73) Assignee: Futurewei Technologies, Inc., Plano, TX (US)

(21) Appl. No.: 14/231,375

(22) Filed: Mar. 31, 2014

(51) Int. Cl. H04N 7/15; G06F 3/01; H04N 13/00; G06F 3/0488; H04N 7/14; G06T 19/00; G06F 3/14

(52) U.S. Cl. CPC H04N 7/157; G06T 19/006; G06F 3/017; G06F 3/1454; G06F 3/0488; H04N 7/147; H04N 13/0037; H04N 13/0059; G06T 2219/016; G06T 2219/2012; G06F 2203/04808; G06F 2211/005; H04N 2013/0077; H04N 2013/0092

(57) ABSTRACT

Embodiments of the present invention provide a novel system and/or method for performing over-the-network collaborations and interactions between remote end-users. Embodiments of the present invention produce the perceived effect of each user sharing a same physical workspace while each person is actually located in separate physical environments. In this manner, embodiments of the present invention allow for more seamless interactions between users while relieving them of the burden of using common computer peripheral devices such as mice, keyboards, and other hardware often used to perform such interactions.

### BACKGROUND OF THE INVENTION

Remote collaboration technologies, such as video conferencing software, are used to conference multiple users from remote locations together by way of simultaneous two-way transmissions. However, many conventional systems for performing such tasks are unable to establish communication environments in which participants are able to enjoy a sense of shared presence within the same physical workspace. As such, collaborations and interactions performed over a communications network between remote users can be a difficult task. Accordingly, a need exists for a solution that provides participants of collaborative sessions performed over communication networks with the sensation of sharing a same physical workspace with each other in a manner that also improves user experience during such events.

### SUMMARY OF THE INVENTION

Embodiments of the present invention provide a novel system and/or method for performing over-the-network collaborations and interactions between remote end-users. Embodiments of the present invention produce the perceived effect of each user sharing a same physical workspace while each person is actually located in separate physical environments. In this manner, embodiments of the present invention allow for more seamless interactions between users while relieving them of the burden of using common computer peripheral devices such as mice, keyboards, and other hardware often used to perform such interactions.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1A depicts an exemplary hardware configuration implemented on a client device for performing augmented reality-enabled interactions and collaborations in accordance with embodiments of the present invention.

FIG. 1B depicts exemplary components resident in memory executed by a client device for performing augmented reality-enabled interactions and collaborations in accordance with embodiments of the present invention.

FIG. 2 depicts an exemplary local media data computing module for capturing real-world information in real-time from a local environment during performance of augmented reality-enabled interactions and collaborations in accordance with embodiments of the present invention.

FIG. 3 depicts an exemplary remote media data computing module for processing data received from remote client devices over a communications network during performance of augmented reality-enabled interactions and collaborations in accordance with embodiments of the present invention.

FIG. 4 depicts an exemplary object-based virtual space composition module for generating a virtualized workspace display for performing augmented reality-enabled interactions and collaborations in accordance with embodiments of the present invention.

FIG. 5 depicts an exemplary a multi-client real-time communication for performing augmented reality-enabled interactions and collaborations in accordance with embodiments of the presentation.

FIG. 6A is a flowchart of an exemplary computer-implemented method for generating local media data during a collaborative session performed over a communications network in accordance with embodiments of the present invention.

FIG. 6B is a flowchart of an exemplary computer-implemented method of generating configurational data for creating a virtual workspace display for a collaborative session performed over a communications network in accordance with embodiments of the present invention.

FIG. 6C is a flowchart of an exemplary computer-implemented method of contemporaneously rendering a virtual workspace display and detecting gesture input during a collaborative session performed over a communications network in accordance with embodiments of the present invention.

FIG. 7A depicts an exemplary use case for performing augmented reality-enabled interactions and collaborations in accordance with embodiments of the present invention.

FIG. 7B depicts another exemplary use case for performing augmented reality-enabled interactions and collaborations in accordance with embodiments of the present invention.

FIG. 7C depicts yet another exemplary use case for performing augmented reality-enabled interactions and collaborations in accordance with embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which can be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure can be practiced without these specific details. In other instances, well-known methods, procedures, components, and circuits have not been described in detail so as not to unnecessarily obscure aspects of the present disclosure.

Reference will now be made in detail to the preferred embodiments of the claimed subject matter, a method and system for the use of a radiographic system, examples of which are illustrated in the accompanying drawings. While the claimed subject matter will be described in conjunction with the preferred embodiments, it will be understood that they are not intended to limit these embodiments. On the contrary, the claimed subject matter is intended to cover alternatives, modifications and equivalents, which may be included within the spirit and scope as defined by the appended claims.

Furthermore, in the following detailed descriptions of embodiments of the claimed subject matter, numerous specific details are set forth in order to provide a thorough understanding of the claimed subject matter. However, it will be recognized by one of ordinary skill in the art that the claimed subject matter may be practiced without these specific details. In other instances, well known methods, procedures, components, and circuits have not been described in detail as not to obscure unnecessarily aspects of the claimed subject matter.

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer generated step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present claimed subject matter, discussions utilizing terms such as “capturing”, “receiving”, “rendering” or the like, refer to the action and processes of a computer system or integrated circuit, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

Accordingly, embodiments of present invention provide a system and/or method for performing augmented reality-enabled interactions and collaborations.

### Exemplary Client Device for Performing Augmented Reality-Enabled Interactions and Collaborations

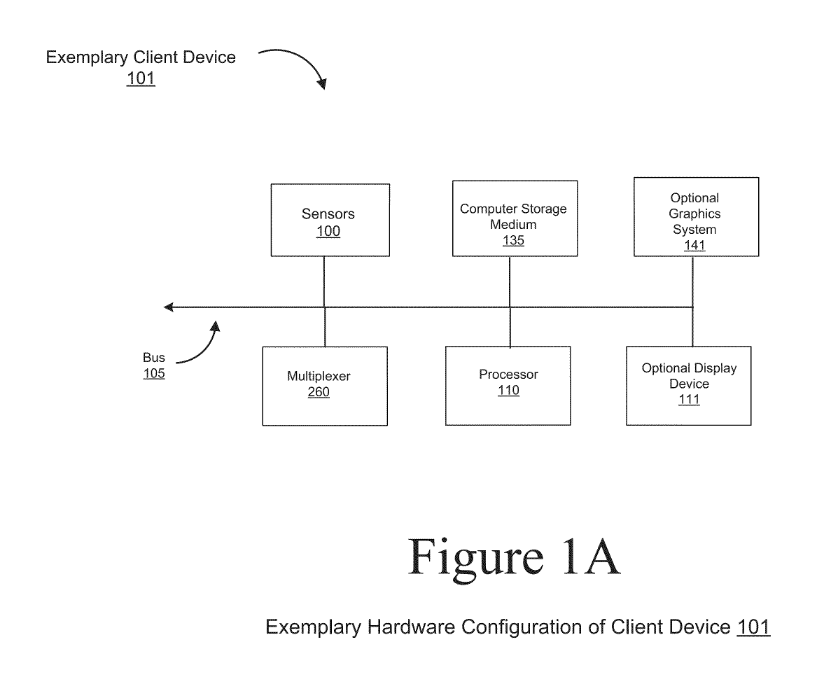

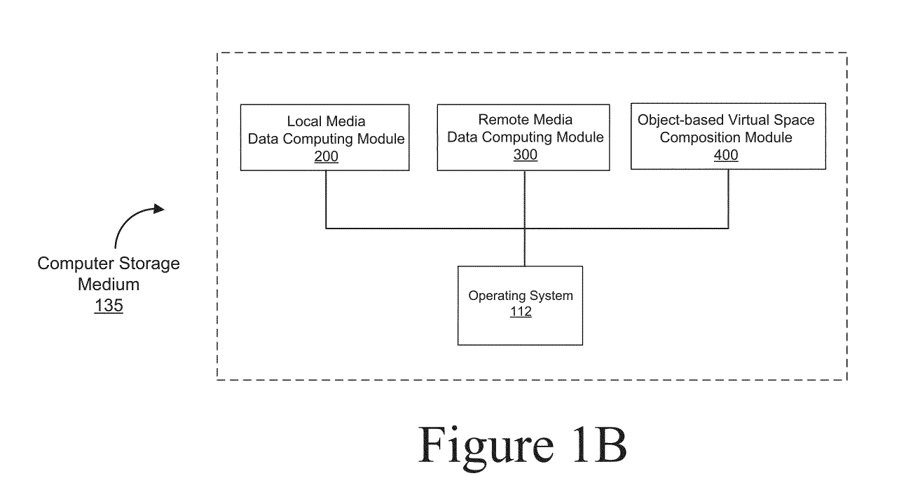

FIG. 1A depicts an exemplary hardware configuration used by various embodiments of the present invention. Although specific components are disclosed in FIG. 1A, it should be appreciated that such components are exemplary. That is, embodiments of the present invention are well suited to having various other hardware components or variations of the components recited in FIG. 1A. It is appreciated that the hardware components in FIG. 1A can operate with other components than those presented, and that not all of the hardware components described in FIG. 1A are required to achieve the goals of the present invention.

Client device 101 can be implemented as an electronic device capable of communicating with other remote computer systems over a communications network. Client device 101 can be implemented as, for example, a digital camera, cell phone camera, portable electronic device (e.g., audio device, entertainment device, handheld device), webcam, video device (e.g., camcorder) and the like. Components of client device 101 can comprise respective functionality to determine and configure respective optical properties and settings including, but not limited to, focus, exposure, color or white balance, and areas of interest (e.g., via a focus motor, aperture control, etc.). Furthermore, components of client device 101 can be coupled via internal communications bus 105 and receive/transmit image data for further processing over such communications bus.

In its most basic hardware configuration, client device 101 can comprise sensors 100, computer storage medium 135, optional graphics system 141, multiplexer 260, processor 110, and optional display device 111.

Sensors 100 can include a plurality of sensors arranged in a manner that captures different forms of real-world information in real-time from a localized environment external to client device 101. Optional graphics system 141 can include a graphics processor (not pictured) operable to process instructions from applications resident in computer readable storage medium 135 and to communicate data with processor 110 via internal bus 105. Data can be communicated in this fashion for rendering the data on optional display device 111 using frame memory buffer(s).

In this manner, optional graphics system 141 can generate pixel data for output images from rendering commands and may be configured as multiple virtual graphic processors that are used in parallel (concurrently) by a number of applications executing in parallel. Multiplexer 260 includes the functionality to transmit data both locally and over a communications network. As such, multiplexer 260 can multiplex outbound data communicated from client device 101 as well as de-multiplex inbound data received by client device 101. Depending on the exact configuration and type of client device, computer readable storage medium 135 can be volatile (such as RAM), non-volatile (such as ROM, flash memory, etc.) or some combination of the two. Portions of computer readable storage medium 135, when executed, facilitate efficient execution of memory operations or requests for groups of threads.

FIG. 1B depicts exemplary computer storage medium components used by various embodiments of the present invention. Although specific components are disclosed in FIG. 1B, it should be appreciated that such computer storage medium components are exemplary. That is, embodiments of the present invention are well suited to having various other components or variations of the computer storage medium components recited in FIG. 1B. It is appreciated that the components in FIG. 1B can operate with other components than those presented, and that not all of the computer storage medium components described in FIG. 1B are required to achieve the goals of the present invention.

As depicted in FIG. 1B, computer readable storage medium 135 can include an operating system (e.g., operating system 112). Operating system 112 can be loaded into processor 110 when client device 101 is initialized. Also, upon execution by processor 110, operating system 112 can be configured to supply a programmatic interface to client device 101. Furthermore, as illustrated in FIG. 1B, computer readable storage medium 135 can include local media data computing module 200, remote media data computing module 300 and object-based virtual space composition module 400, which can provide instructions to processor 110 for processing via internal bus 105. Accordingly, the functionality of local media data computing module 200, remote media data computing module 300 and object-based virtual space composition module 400 will now be discussed in greater detail.

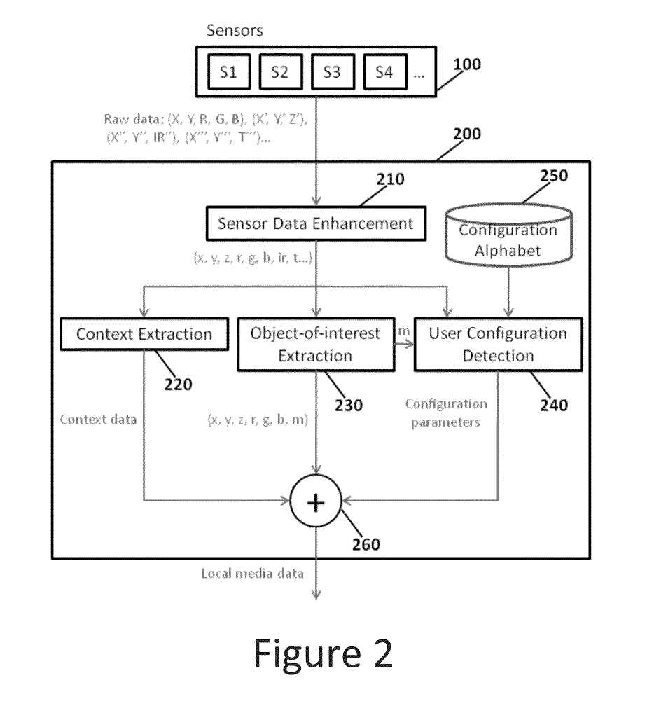

FIG. 2 describes the functionality of local media data computing module 200 in greater detail in accordance with embodiments of the present invention. As illustrated in FIG. 2, sensors 100 includes a set of sensors (e.g., S1, S2, S3, S4, etc.) arranged in a manner that captures different forms of real-world information in real-time from a localized environment external to client device 101. As such, different sensors within sensors 100 can capture various forms of external data such as video (e.g., RGB data), depth information, infrared reflection data, thermal data, etc. For example, an exemplary set of data gathered by sensors 100 at time tᵢ, may be depicted as:

(X, Y, R, G, B) for texture (image) data;
(X′, Y′, Z′) for depth data;
(X″, Y″, IR″) for infrared data;
(X′″, Y′″, T′″) for thermal data
where X and Y represent spatial coordinates and prime marks denote different coordinate systems; R, G, and B values each represent a respective color channel value (e.g., red, green and blue channels, respectively); Z represents a depth value; IR represents infrared values; and T represents thermal data. In this manner, client device 101 can acquire a set of readings from different sensors within sensors 100 at any given time in the form of data maps.

Sensor data enhancement module 210 includes the functionality to pre-process data received via sensors 100 before being passed on to other modules within client device 101 (e.g., context extraction 220, object-of-interest extraction 230, user configuration detection 240, etc.). For example, raw data obtained by each of the different sensors within sensors 100 may not necessarily correspond to a same spatial coordinate system. As such, sensor data enhancement module 210 can perform alignment procedures such that each measurement obtained by sensors within sensors 100 can be harmonized into one unified coordinate system. In this manner, information acquired from the different sensors can be combined and analyzed jointly by other modules within client device 101.

For example, during alignment procedures, sensor data enhancement module 210 can calibrate the appropriate transformation matrices for each sensor's data into a referent coordinate system. In one instance, the referent coordinate system created by sensor data enhancement module 210 may be the intrinsic coordinate system of one of the sensors of sensors 100 (e.g., video sensor) or a new coordinate system that is not associated with any of the sensors' respective coordinate systems. For example, a resultant set of transforms applied to raw sensor data acquired by a sensor acquiring color (e.g., video sensor) may be depicted as:

(X*, Y*, R*, G*, B*)=T_{rgb} (X, Y, R, G, B) for texture (image) data;
(X*, Y*, Z*)=T_{z} (X′, Y′, Z′) for depth data;
(X*, Y*, (IR)*)=Tᵢᵣ (X″, Y″, IR″) for infrared data;
(X*, Y*, T*)=Tₜ (X′″, Y′″, T′″) for thermal data
where the transforms T_{rgb}, T_{z}, Tᵢᵣ, and Tₜ have been previously determined by registration procedures for each sensor of sensors 100. Transforms T can be affine transforms (i.e. T(v)=Av+b, where v is the input vector to be transformed, A is a matrix, and b is another vector), linear transforms, or nonlinear transforms. After the performance of alignment procedures, each point in the referent coordinate system, described by (X*, y*) should have associated values from all the input sensors.

In certain scenarios, data obtained from sensors 100 can be noisy. Additionally, data maps can contain points at which the values are not known or defined, either due to the imperfections of a particular sensor or as a result of re-aligning the data from different viewpoints in space. As such, sensor data enhancement module 210 can also perform corrections to values of signals corrupted by noise or where the values of signals are not defined at all. Accordingly, the output data of sensor data enhancement module 210 can be in the form of updated measurement maps (e.g., denoted as (x, y, z, r, g, b, ir, t . . . ) in FIG. 2) which can then be passed to other components within client device 101 for further processing.

Object-of-interest extraction module 230 includes the functionality to segment a local user and/or any other object of interest (e.g., various physical objects that the local user wants to present to the remote users, physical documents relevant for the collaboration, etc.) based on data received via sensor data enhancement module 210 during a current collaborative session (e.g., teleconference, telepresence, etc.). Object-of-interest extraction module 230 can detect objects of interest by using external data gathered via sensors 100 (e.g., RGB data, infrared data, thermal data) or by combining the different sources and processing them jointly. In this manner, object-of-interest extraction module 230 can apply different computer-implemented RGB segmentation procedures, such as watershed, mean shift, etc., to detect users and/or objects. As illustrated in FIG. 2, the resultant output produced by object-of-interest extraction module 230 (e.g., (x,y,z,r,g,b,m)) can include depth data (e.g., coordinates (x,y,z)) and/or RGB map data (e.g., coordinates (r,g,b)), along with object-of-interest data map (m). For example, further information and details regarding RGB segmentation procedures may be found with reference to U.S. Provisional Application No. 61/869,574 entitled “TEMPORALLY COHERENT SEGMENTATION OF RGBt VOLUMES WITH AID OF NOISY OR INCOMPLETE AUXILIARY DATA,” which was filed on Aug. 23, 2013 by inventor Jana Ehmann, which is incorporated herein by reference in its entirety. This result can be then forwarded to multiplexer 260, as well as to the user configuration detection module 240 for further processing.

Context extraction module 220 includes the functionality to automatically extract high-level information concerning local users within their respective environments from data received via sensor data enhancement module 210. For instance, context extraction module 220 can use computer-implemented procedures to analyze data received from sensor data enhancement module 210 concerning a local user's body temperature and/or determine a user's current mood (e.g., angry, bored, etc.). As such, based on this data, context extraction module 220 can inferentially determine whether the user is actively engaged within a current collaborative session.

In another example, context extraction module 220 can analyze the facial expressions, posture and movement of a local user to determine user engagement. Determinations made by context extraction module 220 can be sent as context data to the multiplexer 260, which further transmits the data both locally and over a communications network. In this manner, context data may be made available to the remote participants of a current collaborative session or it can affect the way the data is presented to the local user locally.

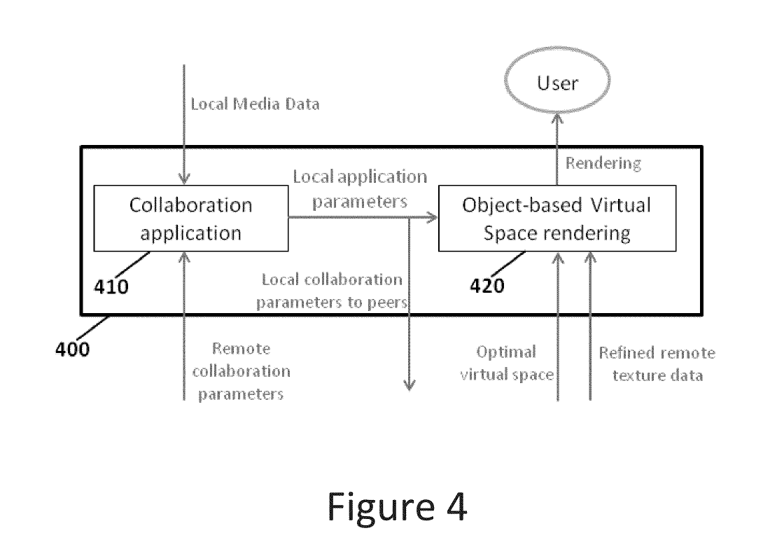

User configuration detection module 240 includes the functionality to use data processed by object-of-interest extraction module 230 to determine the presence of a recognized gesture performed by a detected user and/or object. For example, in one embodiment, user configuration detection module 240 can detect and extract a subset of points associated with a detected user's hand. As such, user configuration detection module 240 can then further classify and label points of the hand as a finger or palm. Hand features can be detected and computed based on the available configurations in known to configuration alphabet 250, such as hand pose, finger pose, relative motion between hands, etc. Additionally, user configuration detection module 240 can detect in-air gestures, such as, for example, “hand waving,” or “sweeping to the right.” In this manner, user configuration detection module 240 can use a configuration database to determine how to translate a detected configuration (hand pose, finger pose, motion etc.) into a detected in-air gesture. The extracted hand features and, if detected, information about the in-air gesture can then be sent to object-based virtual space composition module 400 (e.g., see FIG. 4) for further processing.

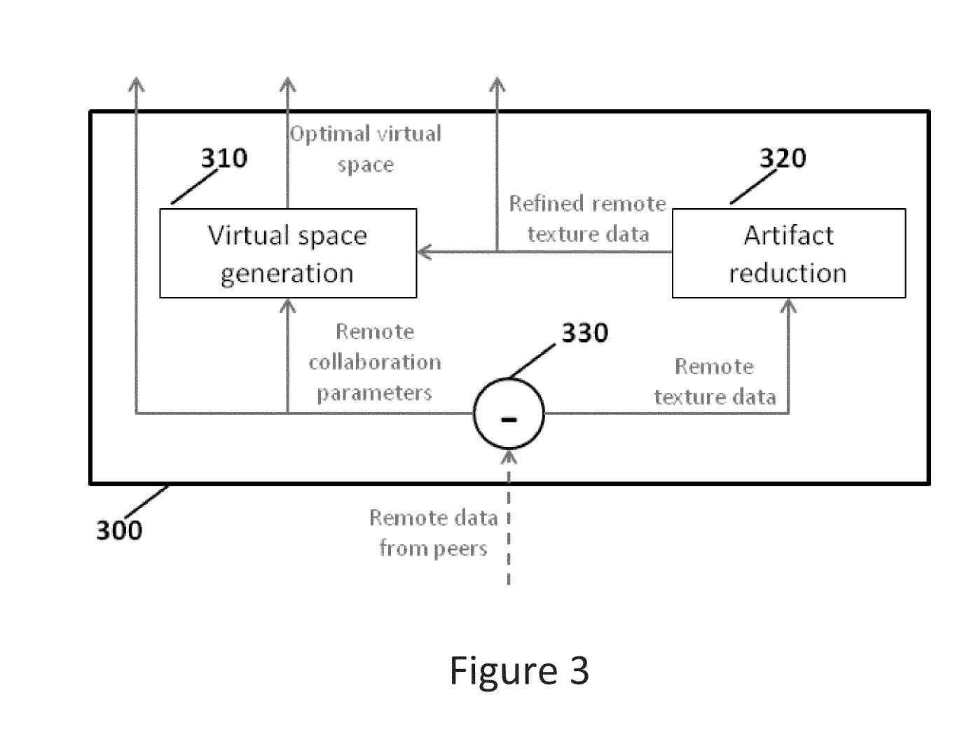

FIG. 3 describes the functionality of remote media data computing module 300 in greater detail in accordance with embodiments of the present invention. Remote media data computing module 300 includes the functionality to receive multiplexed data from remote client device peers (e.g., local media data generated by remote client devices in a manner similar to client device 101) and de-multiplex the inbound data via de-multiplexer 330. Data can be de-multiplexed into remote collaboration parameters (that include remote context data) and remote texture data, which includes depth (x, y, z), texture (r, g, b) and/or object-of-interest (m) data from the remote peers' physical environments. As such, this information can then be distributed to different components within client device 101 for further processing.

Artifact reduction module 320 includes the functionality receive remote texture data from de-multiplexer 330 and minimize the appearance of segmentation errors to create a more visually pleasing rendering of remote user environments. In order to increase the appeal of the subject's rendering in the virtual space and to hide the segmentation artifacts such as noisy boundaries, missing regions etc., the blending of the segmented user and/or the background of the user can be accomplished through computer-implemented procedures involving contour-hatching textures. Further information and details regarding segmentation procedures may be found with reference to U.S. Patent Publication. No. US 2013/0265382 A1 entitled “VISUAL CONDITIONING FOR AUGMENTED-REALITY-ASSISTED VIDEO CONFERENCING,” which was filed on Dec. 31, 2012 by inventors Onur G. Guleryuz and Antonius Kalker, which is incorporated herein by reference in its entirety. These procedures can wrap the user boundaries and reduce the appearance of segmentation imperfections.

Artifact reduction module 320 can also determine the regions within remote user environments that need to be masked, based on potential estimated errors of a given subject's segmentation boundary. Additionally, artifact reduction module 320 can perform various optimization procedures that may include, but are not limited to, adjusting the lighting of the user's visuals, changing the contrast, performing color correction, etc. As such, refined remote texture data can be forwarded to the object-based virtual space composition module 400 and/or virtual space generation module 310 for further processing.

Virtual space generation module 310 includes the functionality to configure the appearance of a virtual workspace for a current collaborative session. For instance, based on a set of pre-determined system settings, virtual space generation module 310 can select a room size or room type (e.g., conference room, lecture hall, etc.) and insert and/or position virtual furniture within the room selected. In this manner, virtualized chairs, desks, tables, etc. can be rendered to give the effect of each participant being seated in the same physical environment during a session. Also, within this virtualized environment, other relevant objects such as boards, slides, presentation screens, etc. that are necessary for the collaborative session can also be included within the virtualized workspace.

Additionally, virtual space generation module 310 can enable users to be rendered in a manner that hides the differences within their respective native physical environments during a current collaborative session. Furthermore, virtual space generation module 310 can adjust the appearance of the virtual workspace such that users from various different remote environments can be rendered in a more visually pleasing fashion. For example, subjects of interest that are further away from their respective cameras can appear disproportionally smaller than those subjects that are closer to their respective cameras. As such, virtual space generation module 310 can adjust the appearance of subjects by utilizing the depth information about each subject participating in a collaborative session as well as other objects of interest. In this manner, virtual space generation module 310 can be configured to select a scale to render the appearance of users such that they can fit within the dimensions of a given display based on a pre-determined layout conformity metric.

Furthermore, virtual space generation module 310 can also ensure that the color, lighting, contrast, etc. of the virtual workspace forms a more visually pleasing combination with the appearances of each user. The colors of certain components within the virtual workspace (e.g., walls, backgrounds, furniture, etc.) can be adjusted in accordance to a pre-determined color conformity metric that measures the pleasantness of the composite renderings of the virtual workspace as well as the participants of a collaboration session. As such, maximization of the layout conformity metric and the color conformity metric can result in a number of different virtual environments. Accordingly, virtual space generation module 310 can generate an optimal virtual environment for a given task/collaboration session for any number of users. Accordingly, results generated by virtual space generation module 310 can be communicated to object-based virtual space composition module 400 for further processing.

FIG. 4 describes the functionality of object-based virtual space composition module 400 in greater detail in accordance with embodiments of the present invention. Collaboration application module 410 includes the functionality to receive local media data from local media data computing module 200, as well as any remote collaboration parameters (e.g., gesture data, type status indicator data) from remote media data computing module 300. Based on the data received, collaboration application module 410 can perform various functions that enable a user to interact with other participants during a current collaboration.

For instance, collaboration application module 410 includes the functionality to process gesture data received via user configuration detection module 240 and/or determine whether a local user or a remote user wishes to manipulate a particular object rendered on their respective display screens during a current collaboration session. In this manner, collaboration application module 410 can serve a gesture control interface that enables participants of a collaborative session to freely manipulate digital media objects (e.g., slide presentation, documents, etc.) rendered on their respective display screens, without a specific user maintaining complete control over the entire collaboration session.

For example, collaboration application module 410 can be configured to perform in-air gesture detection and/or control collaboration objects. In this manner, collaboration application module 410 can translate detected hand gestures, such as swiping (e.g., swiping the hand to the right) and determine a corresponding action to be performed in response to the gesture detected (e.g., returning to a previous slide in response to detecting the hand swipe gesture). In one embodiment, collaboration application module 410 can be configured to detect touch input provided by a user via a touch sensitive display panel which expresses the user's desire to manipulate an object currently rendered on the user's local display screen. Manipulation of on-screen data can involve at least one participant and one digital media object. Additionally, collaboration application module 410 can be configured to recognize permissions set for a given collaborative session (e.g., which user is the owner of a particular collaborative process, which user is allowed to manipulate certain media objects, etc.). As such, collaboration application module 410 can enable multiple users to control the same object and/or different objects rendered on their local display screens.

With the assistance of a local graphics system (e.g., optional graphics system 141), object-based virtual space rendering module 420 can render the virtual workspace display using data received from remote client devices and data generated locally (e.g., presentation data, context data, data generated by collaboration application module 410, etc.). In this manner, object-based virtual space rendering module 420 can feed virtual space parameters to a local graphics system for rendering a display to a user (e.g., via optional display device 111). As such, the resultant virtual workspace display generated by object-based virtual space rendering module 420 enables a local user to perceive the effect of sharing a common physical workspace with all remote users participating in a current collaborative session.

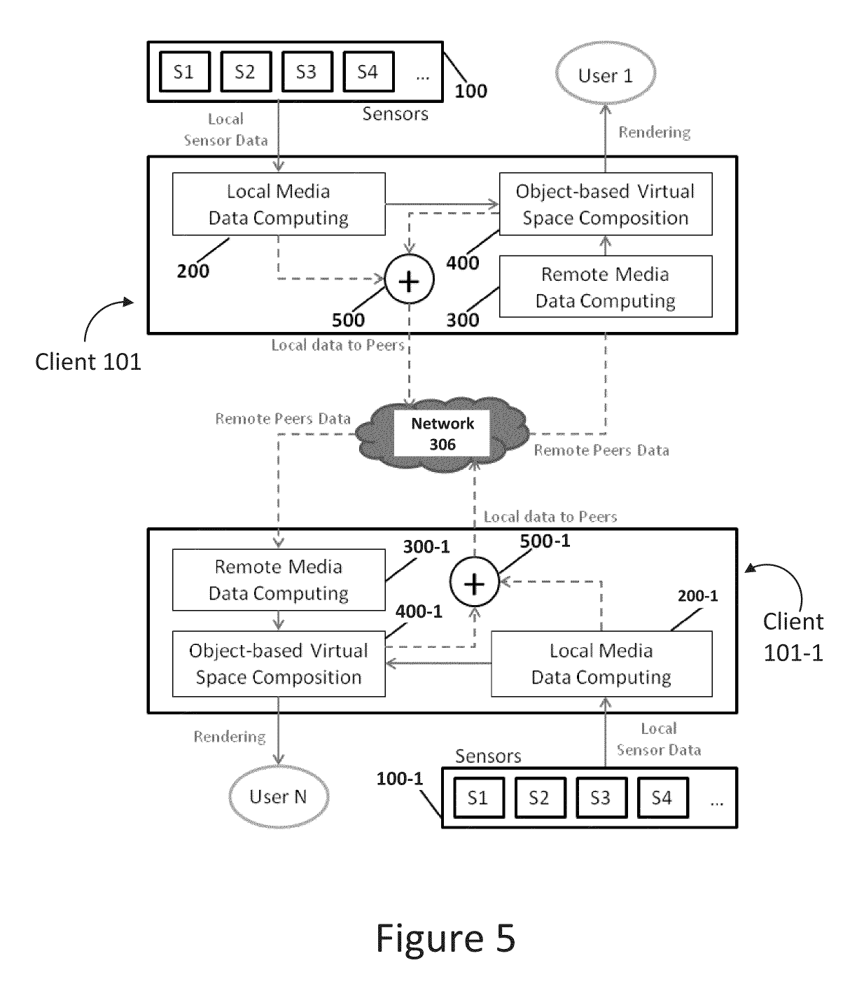

FIG. 5 depicts an exemplary a multi-client, real-time communication in accordance with embodiments of the presentation. FIG. 5 depicts two client devices (e.g., client devices 101 and 101-1) exchanging information over a communication network during the performance of a collaborative session. Accordingly, as illustrated in FIG. 5, client devices 101 and 101-1 can each include a set of sensors 100 that are capable of capturing information from their respective local environments. In a manner described herein, local media data computing modules 200 and 200-1 can analyze their respect local data while remote media data computing modules 300 and 300-1 analyze the data received from each other. Accordingly, in a manner described herein, object-based virtual space composition modules 400 and 400-1 can combine their respective local and remote data for the final presentation to their respective local users for the duration of a collaborative session.

### Exemplary Method for Performing Augmented Reality-Enabled Interactions and Collaborations

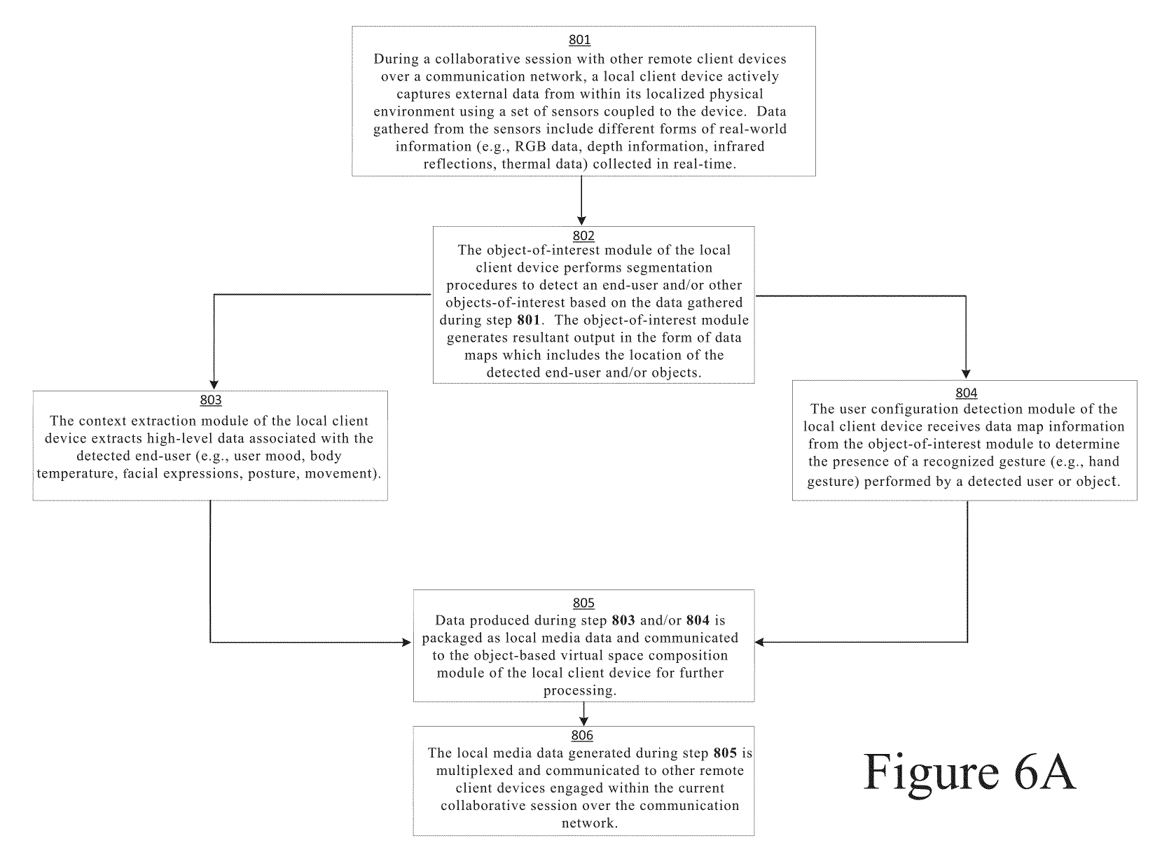

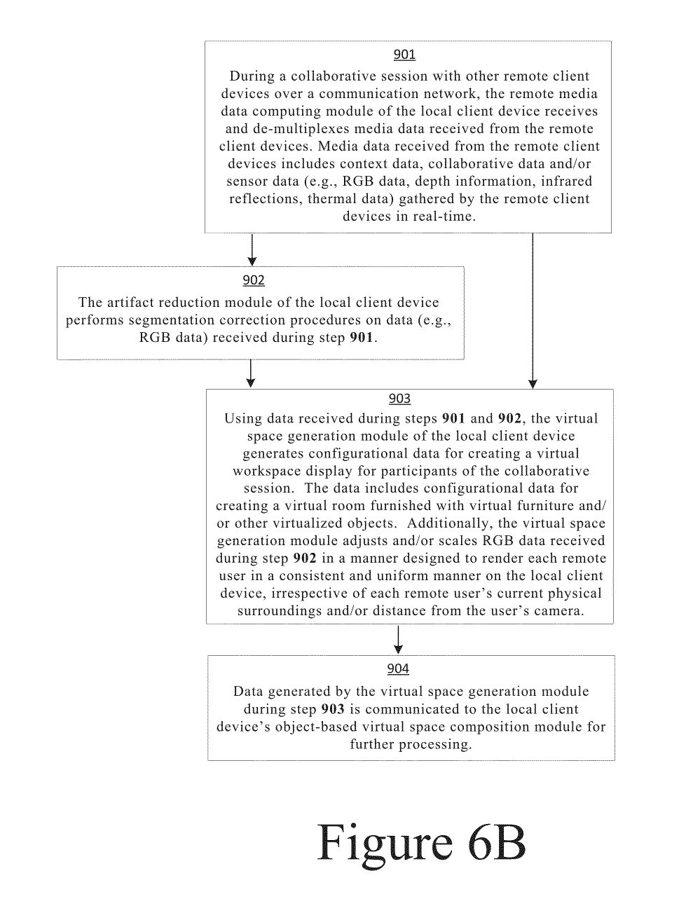

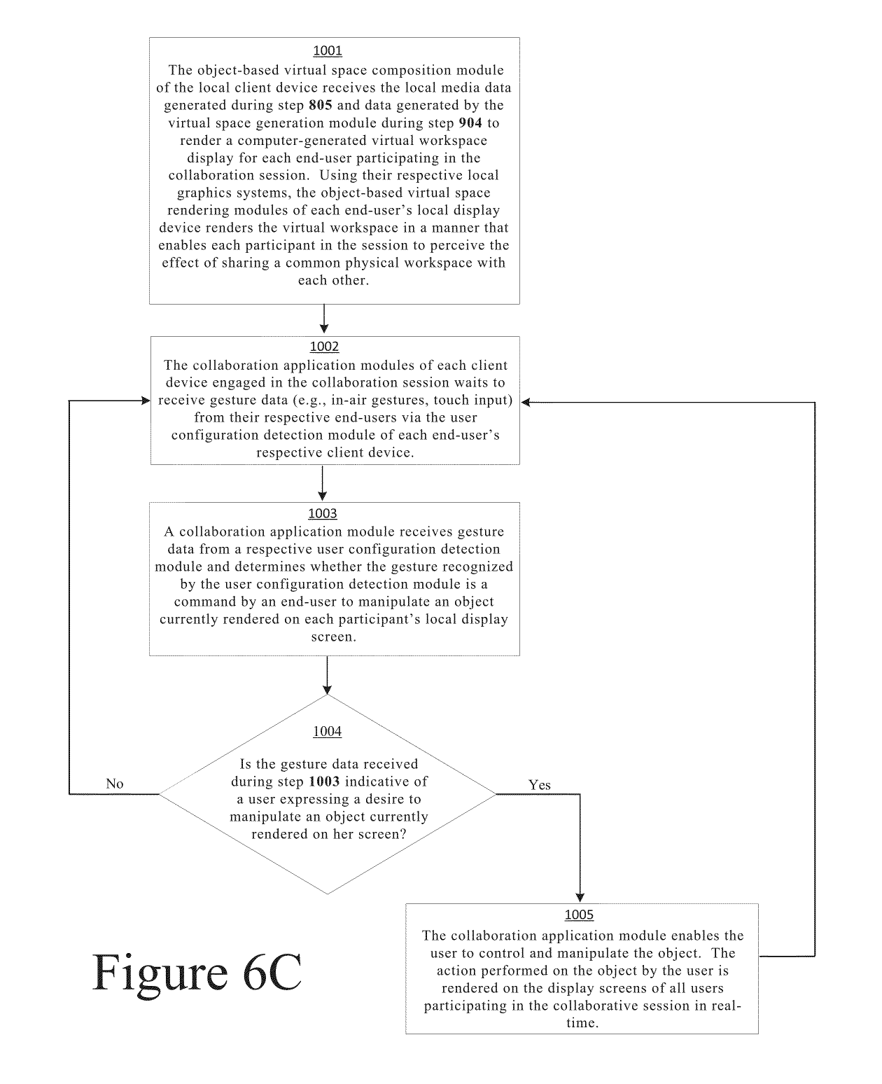

FIG. 6A is a flowchart of an exemplary computer-implemented method for generating local media data during a collaborative session performed over a communications network in accordance with embodiments of the present invention.

At step 801, during a collaborative session with other remote client devices over a communication network, a local client device actively captures external data from within its localized physical environment using a set of sensors coupled to the device. Data gathered from the sensors include different forms of real-world information (e.g., RGB data, depth information, infrared reflection data, thermal data) collected in real-time.

At step 802, the object-of-interest module of the local client device performs segmentation procedures to detect an end-user and/or other objects of interest based on the data gathered during step 801. The object-of-interest module generates resultant output in the form of data maps which includes the location of the detected end-user and/or objects.

At step 803, the context extraction module of the local client device extracts high-level data associated with the end-user (e.g., user mood, body temperature, facial expressions, posture, movement).

At step 804, the user configuration module of the local client device receives data map information from the object-of-interest module to determine the presence of a recognized gesture (e.g., hand gesture) performed by a detected user or object.

At step 805, data produced during step 803 and/or 804 is packaged as local media data and communicated to the object-based virtual space composition module of the local client device for further processing.

At step 806, the local media generated during step 805 is multiplexed and communicated to other remote client devices engaged within the current collaborative session over the communication network.

FIG. 6B is a flowchart of an exemplary computer-implemented method of generating configurational data for creating a virtual workspace display for a collaborative session performed over a communications network in accordance with embodiments of the present invention.

At step 901, during a collaborative session with other remote client devices over a communication network, the remote media data computing module of the local client device receives and de-multiplexes media data received from the remote client devices. Media data received from the remote client devices includes context data, collaborative data and/or sensor data (e.g., RGB data, depth information, infrared reflections, thermal data) gathered by the remote client devices in real-time.

At step 902, the artifact reduction module of the local client device performs segmentation correction procedures on data (e.g., RGB data) received during step 901.

At step 903, using data received during steps 901 and 902, the virtual space generation module of the local client device generates configurational data for creating a virtual workspace display for participants of the collaborative session. The data includes configurational data for creating a virtual room furnished with virtual furniture and/or other virtualized objects. Additionally, the virtual space generation module adjusts and/or scales RGB data received during step 902 in a manner designed to render each remote user in a consistent and uniform manner on the local client device, irrespective of each remote user's current physical surroundings and/or distance from the user's camera.

At step 904, data generated by the virtual space generation module during step 903 is communicated to the local client device's object-based virtual space composition module for further processing.

FIG. 6C is a flowchart of an exemplary computer-implemented method of contemporaneously rendering a virtual workspace display and detecting gesture input during a collaborative session performed over a communications network in accordance with embodiments of the present invention.

At step 1001, the object-based virtual space composition module of the local client device receives the local media data generated during step 805 and data generated by the virtual space generation module during step 904 to render a computer-generated virtual workspace display for each end-user participating in the collaboration session. Using their respective local graphics systems, the object-based virtual space rendering modules of each end-user's local display device renders the virtual workspace in a manner that enables each participant in the session to perceive the effect of sharing a common physical workspace with each other.

At step 1002, the collaboration application modules of each client device engaged in the collaboration session waits to receive gesture data (e.g., in-air gestures, touch input) from their respective end-users via the user configuration detection module of each end-user's respective client device.

At step 1003, a collaboration application module receives gesture data from a respective user configuration detection module and determines whether the gesture recognized by the user configuration detection module is a command by an end-user to manipulate an object currently rendered on each participant's local display screen.

At step 1004, a determination is made by the collaboration application module as to whether the gesture data received during step 1003 is indicative of a user expressing a desire to manipulate an object currently rendered on her screen. If the gesture is determined by the collaboration application module as not being indicative of a user expressing a desire to manipulate an object currently rendered on her screen, then the collaboration application modules of each client device engaged in the collaboration session continue waiting for gesture data, as detailed in step 1002. If the gesture is determined by the collaboration application module as being indicative of a user expressing a desire to manipulate an object currently rendered on her screen, then the collaboration application enables the user to manipulate the object, as detailed in step 1005.

At step 1005, the gesture is determined by the collaboration application module as being indicative of a user expressing a desire to manipulate an object currently rendered on her screen, and therefore, the collaboration application enables the user to control and manipulate the object. The action performed on the object by the user is rendered on the display screens of all users participating in the collaborative session in real-time. Additionally, the system continues to wait for gesture data, as detailed in step 1002.

### Exemplary Use Cases for Performing Augmented Reality-Enabled Interactions and Collaborations

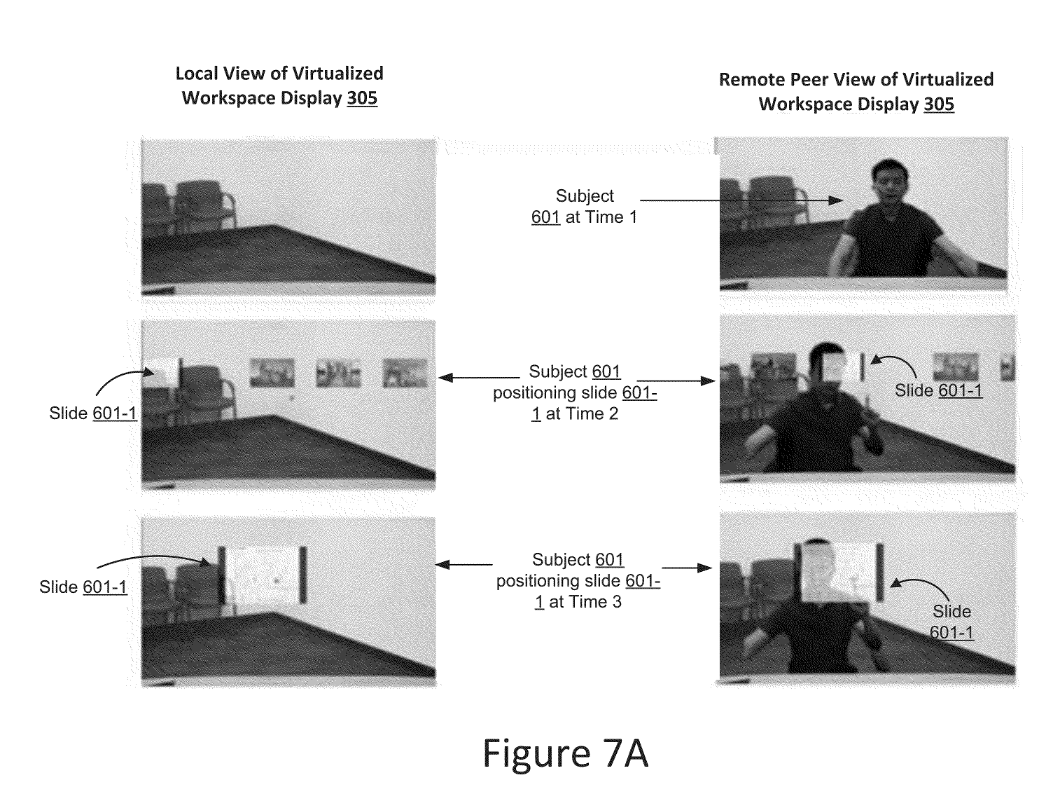

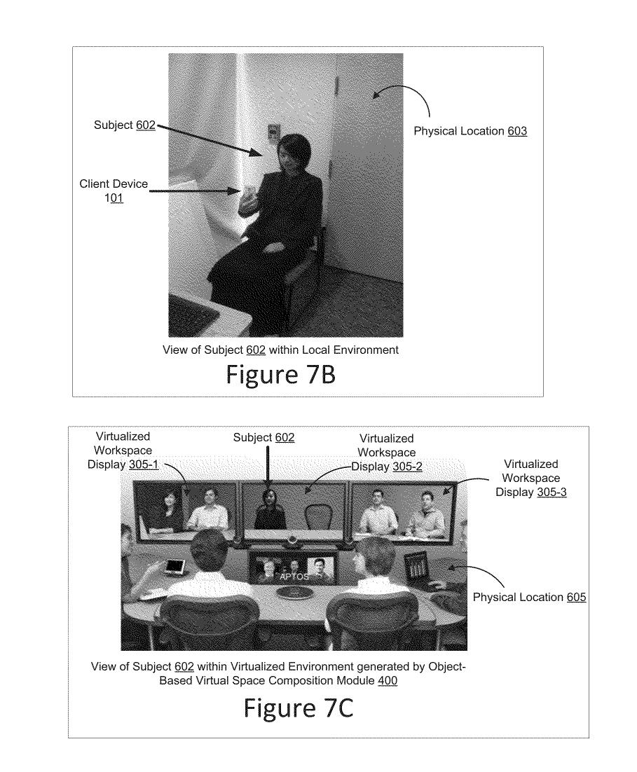

FIG. 7A depicts an exemplary slide presentation performed during a collaborative session in accordance with embodiments of the present invention. FIG. 7A simultaneously presents both a local user's view and a remote user's view of a virtualized workspace display generated by embodiments of the present invention (e.g., virtualized workspace display 305) for the slide presentation. As illustrated in FIG. 7A, using a device similar to client device 101, subject 601 can participate in a collaborative session over a communication network device with other remote participants using similar client devices. As such, embodiments of the present invention can encode and transmit their respective local collaboration application data in the manner described herein. For example, this data can include, but is not limited to, the spatial positioning of slides presented, display scale data, virtual pointer position data, control state data, etc. to the client devices of all remote users viewing the presentation (e.g., during Times 1 through 3).

FIGS. 7B and 7C depict an exemplary telepresence session performed in accordance with embodiments of the present invention. With reference to FIG. 7B, subject 602 can be a user participating in a collaborative session with several remote users (e.g., via client device 101) over a communications network. As illustrated in FIG. 7B, subject 602 can participate in the session from physical location 603, which can be a hotel room, office room, etc. that is physically separated from other participants.

FIG. 7C depicts an exemplary virtualized workspace environment generated during a collaborative session in accordance with embodiments of the present invention. As depicted in FIG. 7C, embodiments of the present invention render virtualized workspace displays 305-1, 305-2, and 305-3 in a manner that enables each participant in the collaborative session (including subject 602) to perceive the effect of sharing a common physical workspace with each other. As such, virtualized workspace displays 305-1, 305-2, and 305-3 include a background or “virtual room” that can be furnished with virtual furniture and/or other virtualized objects. Additionally, virtualized workspace displays 305-1, 305-2, and 305-3 can be adjusted and/or scaled in a manner designed to render each remote user in a consistent and uniform manner, irrespective of each user's current physical surroundings and/or distance from the user's camera. Furthermore, embodiments of the present invention allow users to set up layout of media objects in the shared virtual workspace depending on the type of interaction or collaboration. For instance, users can select a 2-dimensional shared conference space with simple background for visual interaction or a 3-dimensional shared conference space for visual interaction with media object collaboration.

In the foregoing specification, embodiments have been described with reference to numerous specific details that may vary from implementation to implementation. Thus, the sole and exclusive indicator of what is the invention, and is intended by the applicant to be the invention, is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. An apparatus comprising:
a sensor operable to capture a first set of sensor data concerning a local user's physical environment;
a receiver operable to receive a second set of sensor data over a communications network concerning a remote user's physical environment, wherein said first and second sets of sensor data comprise coordinate data gathered from a plurality of different sensors; and
a processor operable to render a virtual workspace display on a computer system using said first and second sets of sensor data, wherein said virtual workspace display comprises computer-generated room furnishings to produce a perceived effect of said local user and said remote user sharing a same physical room.

2. The apparatus as described in claim 1, wherein said sensor is further operable to unify said coordinate data into a common spatial coordinate system for generating said virtual workspace display.

3. The apparatus as described in claim 2, wherein said sensor is further operable to convert said coordinate data into a spatial coordinate system recognized by a specific sensor of said plurality of different sensors.

4. The apparatus as described in claim 1, wherein said processor processes input received from said remote user over said communications network and/or said local user to manipulate an object currently rendered on said virtual workspace display.

5. The apparatus as described in claim 4, wherein said processor processes in-air gesture input received from said remote user or said local user to manipulate said object.

6. The apparatus as described in claim 1, wherein said processor performs computer-implemented segmentation procedures on said first set of sensor data to detect said local user within said local user's physical environment.

7. The apparatus as described in claim 1, wherein said processor performs computer-implemented segmentation procedures on said first set of sensor data to detect an object of interested located within said local user's physical environment.

8. The apparatus as described in claim 1, wherein said virtual workspace display produces a perceived effect of said local user and a plurality of remote users sharing said same physical room.

9. The apparatus as described in claim 8, wherein said processor adjusts said virtual workspace display according to a pre-determined lay-out conformity metric to render said plurality of remote users remote in a uniform manner.

10. The apparatus as described in claim 1, wherein said coordinate data comprises: RGB data, depth information, infrared reflection data and thermal data.

11. A method of interacting over a network, said method comprising:
capturing a first set of sensor data concerning a local user's physical environment;
receiving a second set of sensor data over said communications network concerning a remote user's physical environment, wherein said first and second sets of sensor data comprise coordinate data gathered from a plurality of different sensors; and
rendering a virtual workspace display on a computer system using said first and second sets of sensor data, wherein said virtual workspace display comprises computer-generated room furnishings to produce a perceived effect of said local user and said remote user sharing a same physical room.

12. The method as described in claim 11, wherein said capturing further comprises unifying said coordinate data into a common spatial coordinate system for generating said virtual workspace display.

13. The method as described in claim 12, wherein said capturing further comprises converting said coordinate data into a spatial coordinate system recognized by a specific sensor of said plurality of different sensors.

14. The method as described in claim 11, wherein said capturing further comprises performing computer-implemented segmentation procedures on said first set of sensor data to detect said local user within said local user's physical environment.

15. The method as described in claim 11, wherein said capturing further comprises performing computer-implemented segmentation procedures on said first set of sensor data to detect an object of interest located within said local user's physical environment.

16. The method as described in claim 11, wherein said virtual workspace display produces a perceived effect of said local user and a plurality of remote users sharing said same physical room.

17. The method as described in claim 16, wherein said rendering further comprises adjusting said virtual workspace display according to a pre-determined lay-out conformity metric to render said plurality of remote users remote in a uniform manner.

18. The method as described in claim 11, wherein said rendering further comprises processing input received from said remote user over said communications network and/or said local user to manipulate an object currently rendered on said virtual workspace display.

19. The method as described in claim 18, wherein said processing further comprises processing in-air gesture input received from said remote user or said local user to manipulate said object.

20. The method as described in claim 11, wherein said coordinate data comprises: RGB data, depth information, infrared reflection data and thermal data.
